(19) United States
(12) Patent Application Publication
(10) Pub. No.: US 2020/0127854 A1
(43) Pub. Date: Apr. 23, 2020

(54) TRACKING DIGITAL CERTIFICATE USAGE THROUGH INSTRUMENTATION

(71) Applicant: CA, Inc., New York, NY (US)

(72) Inventor: Srikanth Mandava, Hauppauge, NY (US)

(21) Appl. No.: 16/164,372

(22) Filed: Oct. 18, 2018

(51) Int. Cl. H04L 9/32

(52) U.S. Cl. CPC H04L 9/3268

(57) ABSTRACT

An embodiment of a system is disclosed in which a monitoring computer system may store instrumentation program code, and then copy the instrumentation program code into a server computer system without modifying a communication application module stored in the server computer system. The instrumentation program code, when executed, may causes the server computer system to perform operations including, for example, intercepting a message sent by a client computer system to the communication application module, and detecting a digital certificate included in the message. The instrumentation program code may further cause the server computer system to perform operations such as determining an expiration time of the digital certificate, and initiating a renewal of the digital certificate.

### BACKGROUND

### Technical Field

Embodiments described herein are related to the field of digital certificates, and more particularly to methods for monitoring usage of digital certificates using software instrumentation.

### Description of the Related Art

Digital certificates may be used in computing to authenticate a first entity communicating with a second entity to access particular content or services. Digital certificates may include one or more encryption keys to be used to encrypt or decrypt a message sent or to be sent by the first entity. For example, a client computer system may send a digital certificate as part of an authentication process to access a server computer system. Encryption keys within the certificate may be used to encrypt and or decrypt messages sent between the client and server.

Digital certificates may be issued by a trusted third party not directly associated with the client or server computer systems. The third party may issue digital certificates for use over a limited period of time. Such digital certificates typically include an expiration date or valid date range to indicate a point in time when the certificate is no longer valid. Once a digital certificate has expired, it may no longer be used as part of an authentication process. An owner of an expired certificate may need to request a replacement certificate with a later expiration date from the third-party issuer. Depending on the particular certificate issuer, this process may take minutes, hours, or even days, thereby preventing the certificate owner from accessing the associated content or services until the certificate has been renewed.

### SUMMARY OF THE EMBODIMENTS

Various methods for embodiments of computer systems are disclosed. Broadly speaking, embodiments of systems are disclosed in which a monitoring computer system may store instrumentation program code, and then copy the instrumentation program code into a server computer system without modifying a communication application module stored in the server computer system. The instrumentation program code, when executed, may cause the server computer system to perform operations including, for example, intercepting a message sent by a client computer system to the communication application module, and detecting a digital certificate included in the message. The instrumentation program code may further cause the server computer system to perform operations such as determining an expiration time of the digital certificate, and initiating a renewal of the digital certificate.

In some implementations, initiating the renewal may comprise sending, by the monitoring computer system, a notification to a user of the digital certificate alerting the user of the expiration time. In particular implementations, initiating the renewal may comprise sending, by the monitoring computer system, a renewal request to an issuer of the digital certificate to issue a replacement digital certificate.

In various embodiments, program code for the communication application module may be compiled before the copying. In some embodiments, initiating the renewal of the digital certificate may comprise initiating the renewal in response to determining that the expiration time is within a threshold of a current time.

### BRIEF DESCRIPTION OF THE DRAWINGS

The following detailed description makes reference to the accompanying drawings, which are now briefly described.

FIG. 1A illustrates an embodiment of a system for detecting digital certificate use on a server computer system.

FIG. 1B shows an embodiment of a system for detecting digital certificate use on a client computer system.

FIG. 2 depicts an embodiment of a system for detecting digital certificate use via a proxy computer system.

FIG. 3A illustrates an embodiment of a computer system for detecting a reception of a digital certificate by instrumentation code.

FIG. 3B shows an embodiment of a computer system for detecting a transmission of a digital certificate by instrumentation code.

FIG. 4 depicts a flow diagram for an embodiment of a method for adding instrumentation code to a computer system without modifying an existing communication application module.

FIG. 5 illustrates a flow diagram for an embodiment of a method for detecting use of a digital certificate by instrumentation code.

FIG. 6 depicts a flow diagram for an embodiment of a method for detecting use of a digital certificate by instrumentation code and sending information about the certificate to a monitoring computer system.

FIG. 7 shows an embodiment of a computing device that may be used in the systems shown in the previous figures.

While the embodiments described in this disclosure may be susceptible to various modifications and alternative forms, specific embodiments thereof are shown by way of example in the drawings and will herein be described in detail. It should be understood, however, that the drawings and detailed description thereto are not intended to limit the embodiments to the particular form disclosed, but on the contrary, the intention is to cover all modifications, equivalents and alternatives falling within the spirit and scope of the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112(f) interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

As used throughout this disclosure, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

### DETAILED DESCRIPTION OF EMBODIMENTS

Digital certificates may be used in a variety of authentication operations. For example, digital certificates may be sent from a client computer system to a server computer system to gain access to private data, to access to paid services, to access paid applications, and the like. In some cases, a server may send a digital certificate back to a client requesting access to content to authenticate the server to the client. For example, an online shopping server computer may send a certificate to a shopper's computer system to authenticate that the server is legitimate before the shopper enters payment information. To increase a level of trust, digital certificates may be issued by a third-party entity that is separate from the client and the provider of the data, services, and applications. By using a third-party entity that has an established reputation for tight security, both clients and providers may have an increased level of trust in regards to the safe and secure transmission of information between a client and provider.

As used herein, a “digital certificate,” or simply “certificate,” refers to a message or part of a message sent from a first computer system to a second computer system to establish a trusted communication session between the computer systems. In some cases, after the second computer system receives a certificate from the first computer system, the second sends a different certificate back to the first computer system to establish a trusted two-way communication session. A digital certificate may include various types of information, such as one or more of: an indicator of a type/format of the certificate, a version number for the format, an identifier of an issuer of the certificate, a unique serial number, an identifier of the owner of the certificate, a public encryption key, an indicator of a type of encryption used with the public key, an indicator of a valid date range or expiration date of the certificate, and an encrypted value indicating a validity of the certificate.

Use of digital certificates generated by a third party may make tracking and managing of these certificates difficult. Usage of a digital certificate may typically occur between a client computer system and a server computer system, neither of which may be under any control of the issuer. The issuer of the certificate, therefore, may be unable to easily track usage of issued certificates to gather metrics such as frequency of use, where and when certificates are used, and which certificates are expiring soon. In some cases, an entity operating the client computer, an entity operating the server computer, an entity monitoring usage of particular certificates, and an entity issuing the particular certificates may be independent from one another.

Methods and systems are disclosed herein which may provide entities monitoring usage of particular digital certificates an ability to track and manage these certificates. A monitoring computer system may store instrumentation program code that is copied into a computer system that is used to send or receive certificates. Copying of the instrumentation program code may be accomplished without modifying a communication application module (used to send and/or receive certificates) that is stored in the computer system. The instrumentation program code, when executed, may cause the computer system to detect use of the issuer's digital certificate. The instrumentation code may collect and/or analyze information about the digital certificate. This collected information may be used to improve the user experience with digital certificates. For example, by monitoring frequency of use of certificates, certificates that have not been used for a particular amount of time may voided, possibly eliminating a potential security risk. Similarly, digital certificates that may be expiring soon can be renewed before they expire, avoiding a possible delay that could occur if a user attempts to use an expired certificate.

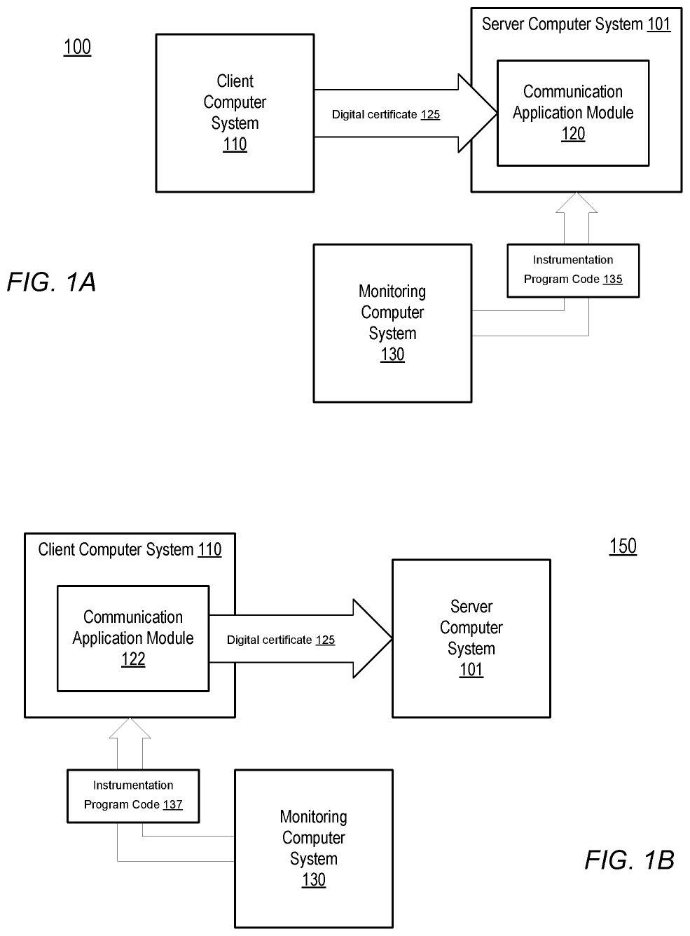

Two embodiments of computer networks that include computer systems utilizing digital certificates are shown in FIGS. 1A and 1B. Networks 100 and 150 of FIGS. 1A and 1B, respectively, each include server computer system 101, client computer system 110 and monitoring computer system 130. In each of networks 100 and 150, client computer system 110 sends digital certificate 125 to server computer system 101. As shown in FIG. 1A, server computer system 101 includes communication application module 120 and monitoring computer system 130 copies instrumentation program code 135 into server computer system 101. In FIG. 1B, client computer system 110 includes communication application module 120 and monitoring computer system 130 copies instrumentation program code 135 into client computer system 110.

As illustrated in FIG. 1A, monitoring computer system 130 stores instrumentation program code 135. Monitoring computer system 130 then copies instrumentation program code 135 into server computer system 101. In various embodiments, monitoring computer system 130 may copy instrumentation program code 135 in response to an initial issuance of digital certificate 125 for use with server computer system 101, or in response to an owner of server computer system 101 entering into an agreement with an owner of monitoring computer system 130 to monitor certificate usage. Instrumentation program code 135 is copied into server computer system 101 without modifying communication application module 120 which has been previously stored in server computer system 101 and used to communicate with client computer system 110.

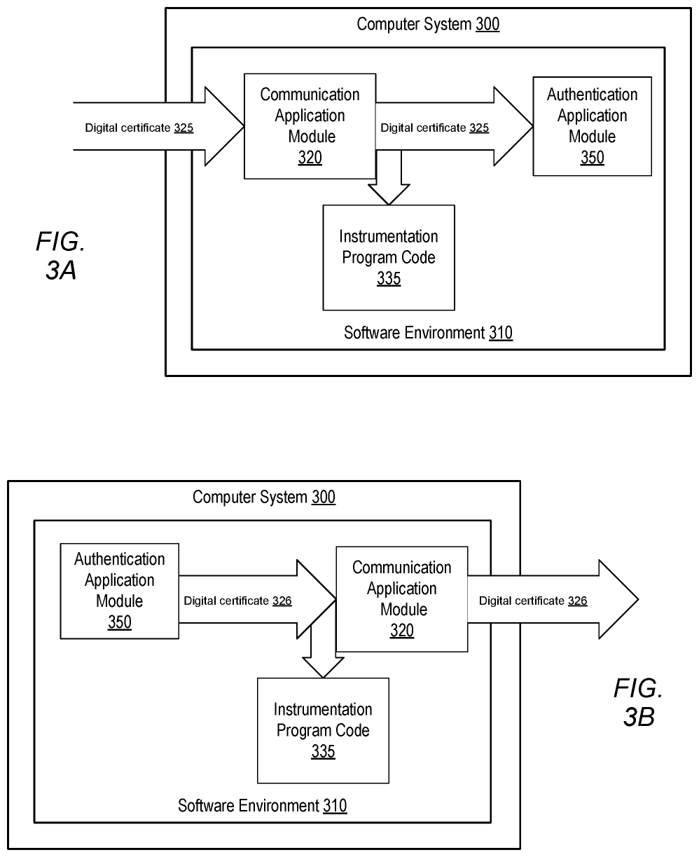

At a point in time after instrumentation program code 135 has been copied to server computer system 101, client computer system 110 sends a message that includes digital certificate 125 to server computer system 101 to, for example, activate an application to which a user of client computer system 110 subscribes. Server computer system 101 receives the message using communication application module 120. Instrumentation program code 135 intercepts the message sent by client computer system 110 to communication application module 120. As used herein, “intercepts” refers to instrumentation code obtaining a copy of messages received by or sent by a communication module. Additional details of instrumentation code, a communication application module, and how instrumentation code obtains messages sent or received by a communication application module are disclosed later in regards to FIG. 3.

Similarly, as shown in FIG. 1B, monitoring computer system 130 stores instrumentation program code 137. In the embodiment of FIG. 1B, monitoring computer system 130 copies instrumentation program code 137 into client computer system 110 without modifying communication application module 122. In various embodiments, monitoring computer system 130 may copy instrumentation program code 137 to client computer system 110 in response to an initial issuance of digital certificate 125 for use with server computer system 101, or in response to an owner of server computer system 101 entering into an agreement with an owner of monitoring computer system 130 to monitor certificate usage. In some embodiments, instrumentation program code 137 may be the same as instrumentation program code 137, while in other cases, instrumentation program code 137 may differ due to differences in hardware of software between client computer system 110 and server computer system 101, including, for example, differences between communication application modules 120 and 122.

As illustrated, communication application module 122 has been previously stored in client computer system 110 and is used for communicating with server computer system 101. Communication between client computer system 110 and server computer system 101 may be performed via any suitable network protocol, such as Ethernet, WiFi, or a combination thereof, and may include use of the Internet or may be limited to a private local area network (LAN).

At a point in time after instrumentation program code 137 has been copied to client computer system 110, client computer system 110 sends, using communication application module 122, a message that includes digital certificate 125 to server computer system 101 to, for example, access information stored on server computer system 101. Instrumentation program code 137 intercepts the message, including digital certificate 125, sent by communication application module 120 to client computer system 110. In the example of FIG. 1B, instrumentation program code 137 may intercept the message before it is sent.

In the embodiments of both FIGS. 1A and 1B, the instrumentation program code, when executed, causes the respective computer system to perform similar operations. Referring to FIG. 1A, after intercepting the message sent by client computer system 110 to communication application module 120 on server computer system 101, instrumentation program code 135 detects digital certificate 125 included in the message. Instrumentation program code 135 then determines an expiration time of the digital certificate and, in response to determining the expiration time, may initiate a renewal of the digital certificate. In some embodiments, instrumentation program code 135 sends a renewal request to an issuer of digital certificate 125 to issue a replacement digital certificate. In other embodiments, instrumentation program code 135 sends a message to monitoring computer system 130, the message including a notification of the expiration time. In either embodiment, the renewal process may be based on the expiration time. For example, monitoring computer system 130 or instrumentation program code 137 may initiate the renewal in response to determining that the expiration time is within a particular threshold of a current time, such as the expiration date is 48 hours away, or one week away.

The renewal process may be performed in various manners. Monitoring computer system 130 or instrumentation program code 135 may send a notification to a user of digital certificate 125, alerting the user of the upcoming expiration time. In some embodiments, one or more specific individuals associated with digital certificate 125 may be alerted. In some cases, a first individual may be alerted, and then a second individual if the first one does not respond in a particular amount of time. Monitoring computer system 130 or instrumentation program code 135 may send a renewal request directly to an issuer of digital certificate 125 to issue a replacement digital certificate. In some embodiments, monitoring computer system 130 may also authorize or initiate an authorization to make a payment associated with the certificate renewal. By renewing a digital certificate before it expires, a user of the certificate may avoid a delay associated with the renewal process when using the certificate to access information or a service that depends on authentication using the certificate.

It is noted that in the disclosed examples, client computer system 110 sends digital certificate 125 to server computer system 101. In some cases, server computer system 101 sends a different digital certificate to client computer system 110. This different certificate may be sent to establish a communication session with client computer system 110 after receiving and validating digital certificate 125, or may be sent to initiate a communication session with client computer system 110, in which case client computer system 110 may respond by sending digital certificate 125 to establish the communication session.

When server computer system 101 sends a digital certificate to client computer system 110, the instrumentation program code performs similar operations as described above. Referring to FIG. 1A, for example, instrumentation program code 135 intercepts a message sent by communication application module 120 to client computer system 110 and detects a different digital certificate included in the detected message. When instrumentation program code 137 is copied to client computer system 110, as in FIG. 1B, the process is similar. Instrumentation program code 137 intercepts a message sent by server computer system 101 to communication application module 122 and detects a different digital certificate included in the message from server computer system 101. In both the examples of FIGS. 1A and 1B, an expiration date of the different digital certificate is determined and may be renewed as described above.

It is noted that FIGS. 1A and 1B are merely examples for demonstrating disclosed concepts. Only components necessary to illustrate these concepts are shown in FIGS. 1A and 1B. Additional and/or different components or modules may be included in other embodiments. For example, although a single client computer system and a single server computer system are illustrated, additional computer systems may be added to the client and/or server side.

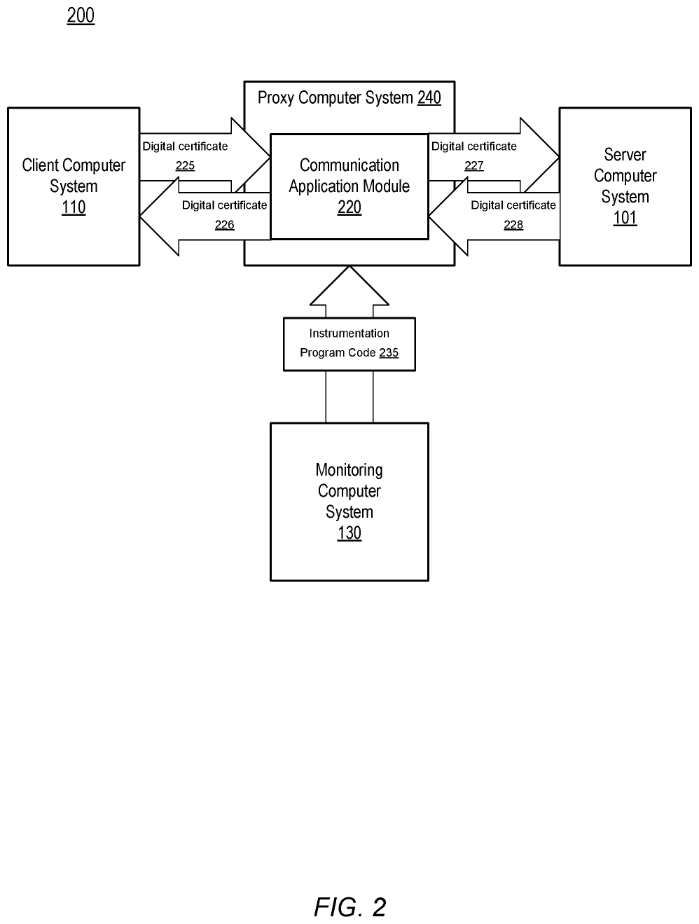

The embodiments of FIGS. 1A and 1B illustrated two examples of computer networks with three computer systems each. Moving to FIG. 2, an embodiment of a computer network that includes four computer systems utilizing digital certificates is illustrated. Like computer networks 100 and 150 in FIGS. 1A and 1B, computer network 200 includes server computer system 101, client computer system 110, and monitoring computer system 130. Computer network 200 also includes proxy computer system 240 which further includes communication application module 220. Except as described otherwise, the functionality of the similarly named and numbered elements is as described in regards to FIGS. 1A and 1B.

As illustrated, proxy computer system 240 serves as an intermediary between client computer system 110 and server computer system 101. When client computer system 110 wants to establish a secure communication session with server computer system 101, instead of sending digital certificate 225 directly to server computer system 101, digital certificate 225 is sent to proxy computer system 240. Proxy computer system 240 authenticates digital certificate 225 and if digital certificate 225 is validated, proxy computer system 240 establishes a first communication session with client computer system 110, which may include sending digital certificate 226 back to client computer system 110. In addition, proxy computer system 240 sends digital certificate 227 to server computer system 101 to initiate a second communication session. If server computer system 101 validates digital certificate 227, then server computer system 101 sends digital certificate 228 back to proxy computer system 240 to establish the second communication session. To establish a communication session between client computer system 110 and server computer system 101, therefore, may include usage of up to four digital certificates. In some embodiments, each of the four digital certificates 225-228 may have a different expiration time. To track usage of the digital certificates passing through proxy computer system 240, instrumentation program code 235 is installed by monitoring computer system 130.

Monitoring computer system 130 stores instrumentation program code 235. In response to, for example, an agreement between an owner of proxy computer system 240 and monitoring computer system 130, monitoring computer system 130 copies instrumentation program code 235 to proxy computer system 240. Source code for communication application module 220 is not modified as a result of this copying.

After instrumentation program code 235 has been copied to proxy computer system 240, instrumentation program code 235 causes proxy computer system to perform similar operations as described above for FIGS. 1A and 1B. When communication application module 220 receives a first message from client computer system 110 that includes digital certificate 225, instrumentation program code 235 intercepts the first message and detects digital certificate 225. An expiration time for digital certificate 225 is determined and instrumentation program code 235 may initiate a renewal of digital certificate 225 based on the expiration time. When proxy computer system 240 responds by sending, via communication application module 220, a second message including digital certificate 226 to client computer system 110, instrumentation program code 235 intercepts the second message, detects digital certificate 226, determines an expiration time, and initiates, if applicable, a renewal of digital certificate 226 based on the expiration time.

Instrumentation program code 235 performs similar operations on additional messages sent, or received, by communication application module 220 to, or from, server computer system 101. Instrumentation program code 235 may, therefore, intercept respective messages with digital certificate 227 and 228, and may initiate renewals of either certificate if applicable based on respectively determined expiration times.

In regards to FIGS. 1A, 1B, and 2, it is noted that various models of ownership and/or control of the computer systems are contemplated. In some embodiments, client computer system 110, server computer system 101, monitoring computer system 130, and, in the embodiment of FIG. 2, proxy computer system 240 may all be owned and/or managed by a single entity such as a corporation. In other embodiments, client computer system 110, server computer system 101, monitoring computer system 130, and proxy computer system 240 may each be owned and/or managed by a different entity. In one embodiment, for example, client computer system 110 may be owned by a first entity, proxy computer system 240 and server computer system 101 may both be owned by a second entity (e.g., a financial services provider), and monitoring computer system 130 may be owned by a third entity, such as an issuer of digital certificates.

Furthermore, in various embodiments, one or more of the computer systems may be combined into a single computer system. For example, in any of the disclosed embodiments, the monitoring computer system may be the client, the server, or the proxy computer system. It is also contemplated that features of the monitoring computer system may be performed by multiple computer systems. For example, a first monitoring computer system may store and copy the instrumentation program code into a client/server/proxy computer system, while a second monitoring computer system receives the usage information from the instrumentation program code.

It is also noted that the embodiment of FIG. 2 is one example. Additional and/or different components or modules may be included in other embodiments. For example, multiple client computer systems and/or multiple server computer systems may be coupled to a proxy computer system, with instrumentation program code tracking usage of digital certificates from all client or server computer systems that pass through the proxy computer system. It is contemplated that some embodiments may combine features from one or more of FIGS. 1A, 1B and 2.

Turning to FIGS. 3A and 3B, embodiments of a computer system that utilize instrumentation program code to track digital certificate usage are illustrated. FIGS. 3A and 3B depict how instrumentation program code interacts with previously installed program code when a computer system receives (FIG. 3A) or sends (FIG. 3B) a digital certificate. In both FIGS. 3A and 3B, computer system 300 includes software environment 310, in which, communication application module 320 and authentication application module 350 may be executed. Instrumentation program code 335 is copied to computer system 300 and may also be executed in software environment 310. In various embodiments, computer system 300 may correspond to any of the previously disclosed server computer system 101, client computer system 110, or proxy computer system 240. Except as described otherwise, the functionality of the illustrated elements is as described for similarly named and numbered components above.

As shown, computer system 300 corresponds to any suitable type of computing device. For example, computer system 300 may be any one of a smartphone, tablet, laptop, desktop, workstation, server, and the like. In some embodiments, computer system 300 may include more than one computing device, such as a bank of server computers. Computer system 300 includes software environment 310 which may enable program applications of one or more types to execute. For example, software environment may correspond to a Java® operating environment that allows applications written in JavaScript® to be executed. In other embodiments, software environment 310 may correspond to an operating system (OS) or to a browser program that enables plug-in or extension applications to be installed and executed.

Communication application module 320 is installed and executes within software environment 310. As used herein, a “communication application module” refers to a software module that provides a link from other software modules and processes executing in computer system 300, to networking hardware, such as Ethernet or WiFi, that further provides access to a network such as a LAN or the Internet. For example, communication application module 320 may be a network driver for an Ethernet card in computer system 300. In other embodiments, communication application module 320 may be a software module in a JavaScript library that links other modules executing in a Java operating environment to one or more network drivers executing outside of the Java operating environment. Communication application module 320 may, in some embodiments, corresponds to communication application modules 120, 122, or 220. Communication application module 320 is a program application that may be written in any suitable programming language, such as Java, Python®, and C derivatives. When a digital certificate is sent from or received by computer system 300, the certificate passes through communication application module 320.

When communication application module 320 receives a digital certificate, the certificate may be sent, either directly or indirectly, to authentication application module 350. Authentication application module 350 is also a program application that may be written in any suitable programming language. As shown, authentication application module 350 is included in software environment 310. In some embodiments, however, authentication application module 350 may be installed and executed outside of software environment 310. In other embodiments, authentication application module 350 may be included as a part of communications application module 320. Authentication application module 350 is used to determine validity of received digital certificates and track and maintain locally stored digital certificates to send to other computer systems, for example, as part of establishing a communication session with another computer system.

Instrumentation program code 335 is copied to computer system 300 by a monitoring computer system such as the previously disclosed monitoring computer system 130. As illustrated, instrumentation program code 335 executes in software environment 310 and intercepts messages between communication application module 320 and authentication application module 350 that include a digital certificate. In various embodiments, however, instrumentation program code 335 may intercept a message during a reception of the message by communication application module 320, during an authentication process performed by authentication application module 350, or after the authentication process by authentication application module 350 has completed. Instrumentation program code 335 extracts information about the certificates, such as an indication of an expiration date, and sends the data to the monitoring computer system. In some embodiments, instrumentation program code 335 compares the expiration date to a current date and may initiate a renewal of the certificate if the amount of time until the expiration date is less than a threshold amount of time. Instrumentation program code 335 may also extract other data from the digital certificate and send this data to the monitoring computer system.

Both communication application module 320 and authentication application module 350 may be written and source code owned by an entity that is different than the entity that creates and maintains instrumentation program code 335. For example, each of communication application module 320, authentication application module 350, and instrumentation program code 335 may be written by different entities and hence, the entity that writes instrumentation program code 335 (henceforth, the monitoring entity) may not have access to the source code of communication application module 320 and authentication application module 350. In some cases, the monitoring entity may have access to code for one or both of the application modules. The owner of computer system 300 (henceforth, the owner entity), however, may not allow changes to the source code of either communication application module 320 and authentication application module 350 since these application modules may be thoroughly tested for reliable operation within computer system 300 and any changes to these modules could impact this reliability.

In order to intercept messages that include digital certificates from communication application module 320, without making any changes to the source code of communication application module 320, instrumentation program code 335 is written using instrumentation techniques. Some software environments, for example, JavaScript, support code instrumentation and may include additional code libraries for implementing instrumentation. Code instrumentation may generally be used by a programmer to observe and debug an application module that the programmer is developing. Instrumentation allows an application module to be observed without modifying its source code. For example, using code instrumentation, classes called within the application module may be identified and then calls to the identified classes may be monitored to identify when a monitored class is called as well as information that is passed to or from the monitored class as part of the call.

Using similar instrumentation techniques, a programmer developing instrumentation program code 335 may identify relevant classes in communication application module 320 used for sending and receiving messages that include digital certificates. The programmer may then create instrumentation program code to monitor the relevant classes in communication application module 320 and detect when a message with a digital certificate is sent or received, as well as intercepting a copy of the message. In various embodiments, instrumentation program code 335 may be written to work with a particular version of communication application module 320 or may be written to work with a variety of known versions.

Once instrumentation program code 335 has been developed, it may be stored in a monitoring computer system and then copied into computer systems that uses a supported version of communication application module 320, such as computer system 300. Instrumentation program code 335 may be copied to computer system 300 in response to an agreement between the owner entity and the monitoring entity. It is noted that program code for communication application module 320 may be compiled before the copying of instrumentation program code 335 occurs.

Referring to FIG. 3A, an example of how instrumentation program code 335 works when computer system 300 receives a message that includes digital certificate 325 is shown. Instrumentation program code 335 may run in the background of software environment 310. A message that includes digital certificate 325 is sent from another computer system and is received by computer system 300 using communication application module 320. Instrumentation classes that are supported by software environment 310 and utilized by instrumentation program code 335 detect calls to monitored classes in communication application module 320 when digital certificate 325 is received. Instrumentation program code 335 receives information about the detected calls and receives a copy of the message. In other words, instrumentation program code 335 intercepts the message. Instrumentation program code 335 then extracts information about digital certificate 325, including an indication of an expiration date of the certificate, and may pass some or all of this information to a monitoring computer system. Instrumentation program code 335 may also initiate a renewal of digital certificate 325 based on the extracted expiration date. Communication application module 320 sends the received message including digital certificate 325 to authentication application module 350, the received message having not been modified due to the intercepting by instrumentation program code 335.

Proceeding to FIG. 3B, a similar example is shown when computer system 300 sends a message that includes digital certificate 326. Authentication application module 350 determines that digital certificate 326 is to be sent to another computer system, and in response, sends a message to communication application module 320 that includes digital certificate 326. When the message is received in communication application module 320, the instrumentation classes utilized by instrumentation program code 335 detect calls to monitored classes. As just described above, instrumentation program code intercepts the message sent to communication application module 320, extracts relevant data and sends the data to the monitoring computer system. Again, instrumentation program code 335 may also initiate a renewal of digital certificate 325 based on the extracted expiration date. Communication application module 320 sends the received message with digital certificate 326 to the other computer system, unaltered by the interception.

At some point in after the installation of instrumentation program code 335 on computer system 300, the code may be updated. For example, a new monitoring computer system may be utilized, the owner entity may replace communication application module 320, general program updates may be made to instrumentation program code 335, or other such circumstances may trigger the update. Updating of instrumentation program code 335 may be performed by replacing the previously copied instrumentation program code 335 with updated instrumentation program code 335a (not illustrated) in software environment 310. Since instrumentation program code 335 and update 335a do not impact a monitored application module, these updates may be performed while excluding code updates for communication application module 320.

It is noted that the embodiments of FIGS. 3A and 3B are merely examples. It is contemplated that operations disclosed in FIGS. 3A and 3B may be combined with the features disclosed in previous embodiments. A different number of application modules may be included in the software environments of other embodiments. For example, operations performed by the authentication application module may be performed instead by the communication application module.

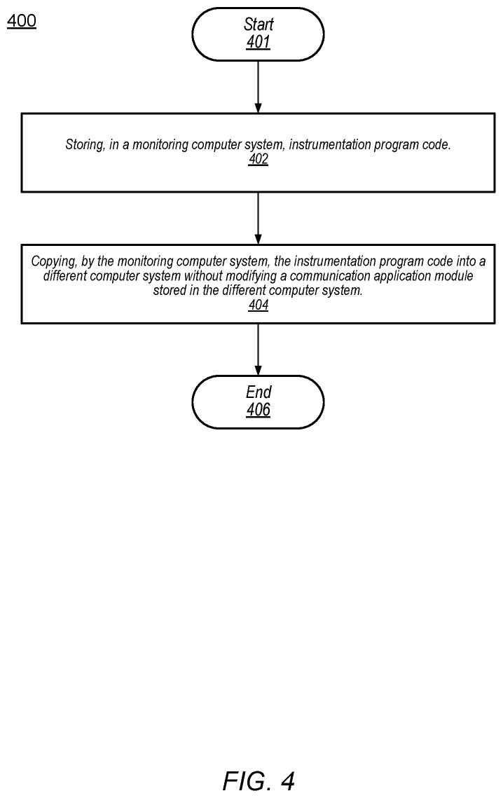

Moving now to FIG. 4, a flow diagram for an embodiment of a method for adding instrumentation program code to a computer system is shown. Method 400 may be applied to a monitoring computer system, such as monitoring computer system 130 shown in FIGS. 1A, 1B, and 2. Referring collectively to FIG. 1A and the flow diagram in FIG. 4, the method begins in block 401.

Instrumentation program code is stored in a monitoring computer system (block 402). As illustrated, instrumentation program code, such as instrumentation program code 135, is created by a programmer for use with one or more communication application modules, such as communication application module 120, and then stored in a monitoring computer system, such as monitoring computer system 130. As shown, monitoring computer system 130 is communicatively coupled to server computer system 101 via one or more network connections. In other embodiments, monitoring computer system 130 may be communicatively coupled to other computer systems, for example, client computer system 110 in FIG. 1B, or proxy computer system 240 in FIG. 2. Instrumentation program code 135, may be stored in any suitable memory accessible by monitoring computer system 130, e.g., an internal or external hard-disk drive, an internal or external solid state drive, removable medium such as a CD or DVD read only memory (ROM), and other forms of non-transient, computer-readable storage.

The monitoring computer system copies the instrumentation program code into a different computer system without modifying a communication application module stored in the different computer system (block 404). As shown, monitoring computer system 130 copies instrumentation program code 135 to server computer system 101. The copying may occur in response to any suitable event, such as an initial reception of a digital certificate by server computer system 101, a purchase or licensing agreement between an operator of monitoring computer system 130 and an operator of server computer system 101, a request for instrumentation program code 135 from an operator of server computer system 101, and other similar events. Instrumentation program code 135, may be stored in server computer system 101 within any suitable and accessible memory, such as described above for block 402.

As depicted, the copying of instrumentation program code 135 occurs after communication application module 120 has been compiled and installed on server computer system 101. Alteration of communication application module 120 due to the copying and subsequent execution of instrumentation program code 135 may not be possible for one or more reasons. The owner of server computer system 101 may not want communication application module 120 to be modified after having performed operational and/or reliability tests involving communication application module 120, as such modifications may require additional testing. Source code for communication application module 120 may not be available to the operators of either sever computer system 101 or monitoring computer system 130. A lack of resources, lack of time, and/or additional costs may prohibit or discourage the modification of communication application module 120. Accordingly, communication application module 120 is not modified by the copying of instrumentation program code 135 to server computer system 101. The method ends in block 406.

It is noted that the embodiment of FIG. 4 is one example of copying instrumentation program code into a computer system. In some embodiments, additional operations may be performed. For example, before copying the code into the different computer system, the monitoring computer system may request and/or establish a secure communication session with the different computer system.

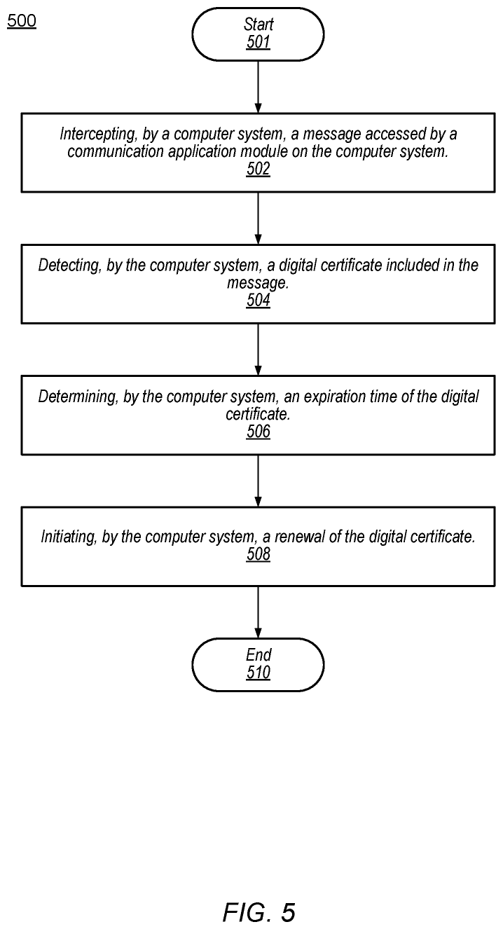

Method 400 of FIG. 4 describes a process for copying instrumentation program code to a computer system. Turning now to FIG. 5, a flow diagram for an embodiment of a method describing operations performed based on instrumentation program code is depicted. Method 500 may be applied to a computer system that executes instructions included in instrumentation program code, such as, for example, server computer system 101 in FIG. 1A, client computer system 110 in FIG. 1B, proxy computer system 240 in FIG. 2, and computer system 300 in FIGS. 3A and 3B. Method 500 may be performed at some point in time after method 400 is performed. Referring collectively to FIG. 3A and method 500, the method begins in block 501 at a point in time after instrumentation program code 335 has been copied from a monitoring computer system to computer system 300 using, for example, method 400.

A computer system intercepts a message accessed by a communication application module on the computer system (block 502). As illustrated, computer system 300, utilizing instrumentation program code 335, intercepts a message received by communication application module 320. In various embodiments, communication application module 320 may receive the message from a different computer system, as shown in FIG. 3A, or from an application within computer system 300, such as authentication application module 350 in FIG. 3B. Using instrumentation classes described above, instrumentation program code 335 detects a reception by communication application module 320 of a message that includes digital certificate 325 and receives a copy of this received message.

The computer system detects a digital certificate included in the message (block 504). As shown, computer system 300 uses instrumentation program code 335 to detect digital certificate 325 in the received message. In some embodiments, instrumentation program code 335 reads at least a portion of received messages, looking for an indication of a digital certificate within a received message. In other embodiments, a particular class may be used by communication application module 320 when sending and/or receiving messages that include digital certificates. Instrumentation program code 335 may look for calls by communication application module 320 to this particular class. Detection of a call to this particular class provides the indication that a message associated with the call includes a digital certificate.

The computer system determines an expiration time of the digital certificate (block 506). Computer system 300, as depicted, uses instrumentation program code 335 to extract information about digital certificate 325. Digital certificate 325 includes an indicator of a valid date range or expiration date of the certificate. Instrumentation program code 335 extracts the date information to determine the expiration date for digital certificate 325.

The computer system initiates a renewal of the digital certificate (block 508). Computer system 300, as illustrated, initiates a renewal process for digital certificate 325 using instrumentation program code 335. In some embodiments, the renewal process may be initiated if the detected expiration date is within a threshold amount of time from a current date. For example, the threshold may be set at 24 hours, resulting in computer system 300 initiating a renewal processes only for digital certificates that expire in 24 hours or less. In various embodiments, the threshold amount of time may be set by a programmer of instrumentation program code 335, or by a variable that is set by an operator of computer system 300 or an operator of the monitoring computer system that installed instrumentation program code 335. The method ends in block 510

It is noted that method 500 of FIG. 5 is merely an example. Some operations, in some embodiments, may be performed in parallel or may be performed in a different order. For example, operations of block 504 may be performed before or in parallel with block 504 if a class can be identified within a communication application module that is called when a digital certificate is being sent or received.

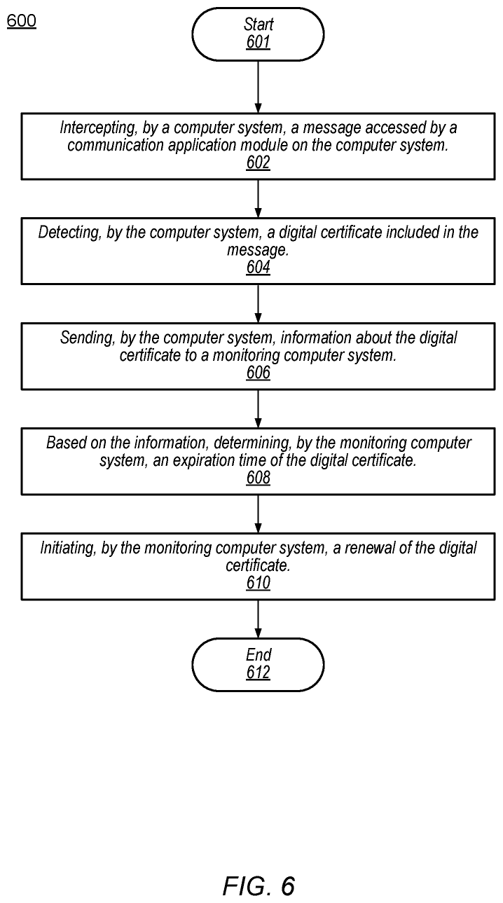

In method 500 of FIG. 5, the instrumentation program code running on the computer system determines the expiration date of the digital certificate. Proceeding now to FIG. 6, a flow diagram for an embodiment of a method in which a monitoring computer system receives information about a detected digital certificate from instrumentation program code running on a different computer system is shown. Method 600 may be applied to a computer network, such as computer networks 100, 150, and 200, in FIGS. 1A, 1B, and 2, respectively. Referring collectively to FIG. 2 and method 600, the method begins in block 601 at a point in time after instrumentation program code 235 has been copied from monitoring computer system 130 to proxy computer system 240 using, for example, method 400.

A computer system intercepts a message accessed by a communication application module on the computer system (block 602). Proxy computer system 240, as shown, utilizes instrumentation program code 235 to intercept a message that includes digital certificate 225. Instrumentation program code 235 detects a reception by communication application module 220 of the message that includes digital certificate 225. Using the instrumentation techniques disclosed above, instrumentation program code 235 receives a copy of this received message, including digital certificate 225.

The computer system detects a digital certificate included in the message (block 604). As depicted, instrumentation program code 235, executing on proxy computer system 240, detects digital certificate 225 in the intercepted message. As described above, instrumentation program code 235 may, in some embodiments, read at least a portion of received messages, to determine if they include a digital certificate. In other embodiments, instrumentation program code 235 may determine that a call to a particular class by communication application module 320 indicates that an associated message included with the call includes a digital certificate.

The computer system sends information about the digital certificate to a monitoring computer system (block 606). As illustrated, proxy computer system 240 uses instrumentation program code 235 to retrieve information about digital certificate 225. As well as an indicator of an expiration time of the certificate, a digital certificate may include one or more of a format indicator, a version number of the format, an identity of the certificate issuer, a unique serial number, an identity of the certificate owner, a public encryption key, an indicator of a type of encryption, and an encrypted value indicating a validity of the certificate. Instrumentation program code 235 extracts at least some of the information, including the expiration time, from digital certificate 225. This extracted information is sent by instrumentation program code 235 to monitoring computer system 130. In some embodiments, the information is sent using communication application module 220, while in other embodiments, a different communication method is used.

Based on the information, the monitoring computer system determines an expiration time of the digital certificate (block 608). Monitoring computer system 130, as shown, receives the information extracted from digital certificate 225. Monitoring computer system 130 retrieves the indicator of the expiration time from the extracted information and may compare this to a current time. In some embodiments, monitoring computer system may perform other types of analysis of the extracted information, such as a frequency of use of digital certificate 225, as well as where and when digital certificate 225 is used.

The monitoring computer system initiates a renewal of the digital certificate (block 610). If the result of the comparison indicates that the expiration time is less than a threshold amount of time from the current time, monitoring computer system 130 initiates a renewal of digital certificate 225. The threshold amount of time may be, in various embodiments, fixed to a particular value or set by an operator of monitoring computer system 130. In some embodiments, the threshold amount of time may vary based on other values included in the extracted information, such as a type of certificate or an identity of the issuer of the certificate. For example, different issuers may specify different lengths of time for renewing a certificate. In such embodiments, monitoring computer system 130 may, therefore, set the threshold amount of time based on the issuer's specified length of time for renewals. The method ends in block 612.

It is noted that the method of FIG. 6 is an example for demonstrating the disclosed embodiments. In other embodiments, additional operations may be included. For example, before the proxy computer system sends the information about the certificate to the monitoring computer system, a secure communication session may be established between the two computer systems.

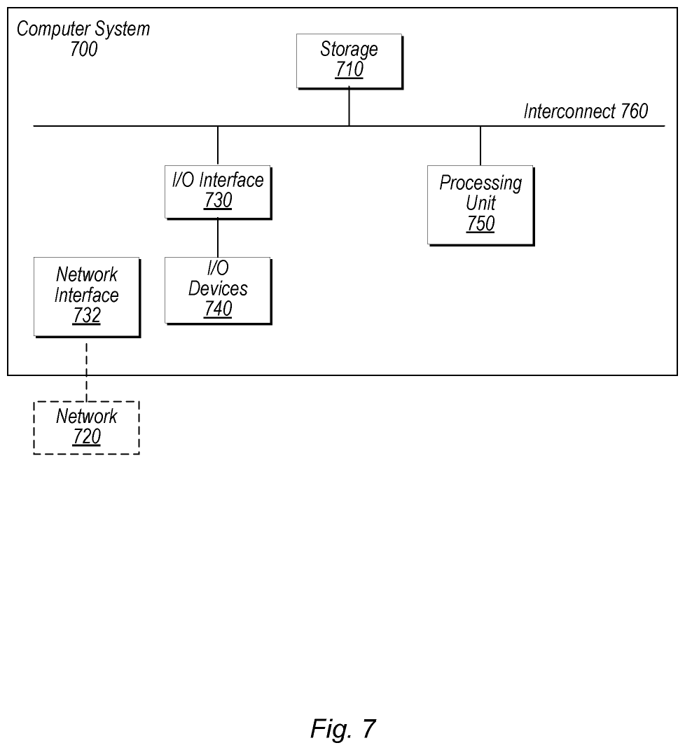

Turning to FIG. 7, a block diagram of an example computer system is illustrated. Computer system 700, in various embodiments, may correspond to any of the computer systems or computing devices disclosed herein, such as, for example, server computer system 101, client computer system 110, monitoring computer system 130, proxy computer system 240, or computer system 300 in FIGS. 1A, 1B, 2, 3A, and 3B. Computer system 700 may be any suitable type of device, including, but not limited to, a personal computer system, desktop computer, mainframe computer system, web server, workstation, or network computer. Furthermore, in some embodiments, computer system 700 may correspond to a mobile device such as, e.g., a tablet computer, smart phone, a laptop computer, or a wearable computer system. As shown, computer system 700 includes processing unit 750, storage subsystem 710, input/output (I/O) interface 730 coupled via an interconnect 760 (e.g., a system bus). I/O interface 730 may be coupled to one or more I/O devices 740. Computer system 700 further includes network interface 732, which may be coupled to network 720 for communication with, for example, other computing devices.

In various embodiments, processing unit 750 includes one or more processors. In some embodiments, processing unit 750 includes one or more coprocessor units. In some embodiments, multiple instances of processing unit 750 may be coupled to interconnect 760. Processing unit 750 (or each processor within 750) may contain a cache or other form of on-board memory. In some embodiments, processing unit 750 may be implemented as a general-purpose processing unit, and in other embodiments it may be implemented as a special purpose processing unit (e.g., an ASIC). In general, computer system 700 is not limited to any particular type of processing unit or processor subsystem.

As used herein, the terms “processing unit” or “processing element” refer to circuitry configured to perform operations or to a memory having program instructions stored therein that are executable by one or more processors to perform operations. Accordingly, a processing unit may be implemented as a hardware circuit implemented in a variety of ways. The hardware circuit may include, for example, custom very-large-scale integration (VLSI) circuits or gate arrays, off-the-shelf semiconductors such as logic chips, transistors, or other discrete components. A processing unit may also be implemented in programmable hardware devices such as field programmable gate arrays, programmable array logic, programmable logic devices, or the like. A processing unit may also be configured to execute program instructions from any suitable form of non-transitory computer-readable media to perform specified operations.

Storage subsystem 710 is usable by processing unit 750 (e.g., to store instructions executable by and data used by processing unit 750). Storage subsystem 710 may be implemented by any suitable type of physical memory media, including hard disk storage, floppy disk storage, removable disk storage, flash memory, random access memory (RAM-SRAM, EDO RAM, SDRAM, DDR SDRAM, RDRAM, etc.), ROM (PROM, EEPROM, etc.), and so on. Storage subsystem 710 may consist solely of volatile memory in one embodiment. Storage subsystem 710 may store program instructions executable by computer system 700 using processing unit 750, including program instructions executable to cause computer system 700 to implement the various applications and methods disclosed herein, including, but not limited to, various versions of instrumentation program code and communication application modules.

In some embodiments, methods and systems disclosed herein may be implemented in whole or in part with computer code that is executable on one or more processor circuits such as processing unit 750. Thus, various operations described herein may be performed by executing program instructions stored on a non-transitory computer-readable medium and executed by processing unit 750. The program instructions may be stored in storage subsystem 710, or provided on any media capable of sharing program code, such as a compact disk (CD) medium, digital versatile disk (DVD) medium, a floppy disk, a flash-based storage, and the like. Additionally, the entire program code, or portions thereof, may be transmitted and downloaded from a software source such as, e.g., via the Internet, or a file transfer protocol (FTP) server, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a mobile computing system such as, for example, in C, C+, HTML, Java, JavaScript, Python, or other such programming languages.

I/O interface 730 may represent one or more interfaces and may be any of various types of interfaces configured to couple to and communicate with other devices, according to various embodiments. In one embodiment, I/O interface 730 is a bridge chip from a front-side to one or more back-side buses. I/O interface 730 may be coupled to one or more I/O devices 740 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.).

It is noted that FIG. 7 is merely one example of a computer system for demonstrating disclosed concepts. Only components and data movement necessary to illustrate these concepts are shown in FIG. 7. Additional and/or different components or data movements may be included in other embodiments. For example, power management and clock generations circuits may be included in other embodiments.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
storing, in a monitoring computer system, instrumentation program code; and
copying, by the monitoring computer system, the instrumentation program code into a server computer system without modifying a communication application module stored in the server computer system, wherein the instrumentation program code, when executed, causes the server computer system to perform operations including:
intercepting a message sent by a client computer system to the communication application module;
detecting a digital certificate included in the message;
determining an expiration time of the digital certificate; and
initiating a renewal of the digital certificate.

2. The method of claim 1, wherein initiating the renewal comprises sending, by the monitoring computer system, a notification to a user of the digital certificate alerting the user of the expiration time.

3. The method of claim 1, wherein initiating the renewal comprises sending, by the monitoring computer system, a renewal request to an issuer of the digital certificate to issue a replacement digital certificate.

4. The method of claim 1, wherein program code for the communication application module is compiled before the copying.

5. The method of claim 1, further comprising:
intercepting, by the instrumentation program code, a different message sent by the communication application module to the client computer system; and
detecting, by the instrumentation program code, a digital certificate included in the different message.

6. The method of claim 1, wherein the communication application module receives the message during the intercepting.

7. The method of claim 1, further comprising initiating the renewal in response to determining that the expiration time is within a threshold of a current time.

8. A method, comprising:
storing, in a monitoring computer system, instrumentation program code; and
copying, by the monitoring computer system, the instrumentation program code into a client computer system without modifying a communication application module stored in the client computer system, wherein the instrumentation program code, when executed, causes the client computer system to perform operations including:
intercepting a message sent by the communication application module to a server computer system;
detecting a digital certificate included in the message;
determining an expiration time of the digital certificate; and
initiating a renewal of the digital certificate.

9. The method of claim 8, wherein program code for the communication application module is compiled before the copying.

10. The method of claim 8, further comprising:
intercepting, by the instrumentation program code, a different message sent by the server computer system to the communication application module; and
detecting, by the instrumentation program code, a digital certificate included in the different message.

11. The method of claim 8, wherein the server computer system receives the message during the intercepting.

12. The method of claim 8, further comprising initiating the renewal in response to determining that the expiration time is within a threshold of a current time.

13. The method of claim 8, further comprising initiating the renewal by sending a message to the monitoring computer system, the message including a notification of the expiration time.

14. A method, comprising:
storing, in a monitoring computer system, instrumentation program code; and
copying, by the monitoring computer system, the instrumentation program code into a proxy computer system without modifying a communication application module stored in the proxy computer system, wherein the instrumentation program code, when executed, causes the proxy computer system to perform operations including:
intercepting a first message sent by a client computer system to the communication application module;
detecting a digital certificate included in the first message;
determining an expiration time of the digital certificate;
initiating a renewal of the digital certificate; and
sending a second message to a server computer system based on the first message.

15. The method of claim 14, further comprising initiating the renewal by sending a message to the monitoring computer system, the message including a notification of the expiration time.

16. The method of claim 14, wherein initiating the renewal comprises sending, by the monitoring computer system, a renewal request to an issuer of the digital certificate to issue a replacement digital certificate.

17. The method of claim 14, wherein program code for the communication application module is compiled before the copying.

18. The method of claim 14, further comprising:
intercepting, by the instrumentation program code, a third message sent by the server computer system to the communication application module included on the proxy computer system; and
detecting, by the instrumentation program code, a digital certificate included in the third message.

19. The method of claim 18, further comprising sending, by the proxy computer system, a fourth message to the client computer system based on the third message.

20. The method of claim 14, further comprising updating the instrumentation program code by replacing the previously copied instrumentation program code with updated instrumentation program code and excluding code updates for the communication application module.
